(19) United States
(12) Patent Application Publication
(10) Pub. No.: US 2011/0038661 A1
(43) Pub. Date: Feb. 17, 2011

(54) Eraser for Dry Erase Markers

(76) Inventors: Brandon Giap, San Diego, CA (US); Christian Q. Giap, San Diego, CA (US); Elizabeth Q. Giap, San Diego, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/858,385

(22) Filed: Aug. 17, 2010

Related U.S. Application Data
(60) Provisional application No. 61/234,579, filed on Aug. 17, 2009.

(51) Int. Cl. B43K 29/00

(52) U.S. Cl. 401/195

(57) ABSTRACT

An eraser for a dry marker is provided allowing for employment by the user to erase markings from a whiteboard while still holding the marker in a writing position. The eraser features a member positioning the eraser material adjacent to the whiteboard during use of the marker. Engagement of the member to the marker body is provided by an easily employed biased clip base or may be accomplished with adhesive. The eraser engaged upon the distal end of the malleable member is adapted for easy user-determined positioning and use in the as-used position for writing. A curve in the member forms a wider space for the fingers of the user holding the marker at the marking end, and positions the erasing material on a first side of the user's fingers and the marker positioned opposite the first side of the space from the erasing material. The eraser material is configured for removal and replacement and may be replaced with different materials and sizes.

This application claims priority to U.S. Provisional Application No. 61/234579, filed Aug. 17, 2009, which is incorporated herein in its entirety by reference. The disclosed device concerns dry erase markers and removal of markings therefrom when imparted by users to whiteboards. More particularly, the device provides a dry ink eraser for whiteboards, which is employable to erase markings from the whiteboard while the user concurrently is holding the marker in an as-used position, in their writing hand without having to remove their grip from the marker.

### FIELD OF THE INVENTION

### Description of Prior Art

The old fashioned chalkboard of slate, on which the instructor wrote with chalk, has given way to a modern substitute. Instead of a porous slate chalkboard, a surface of a relatively non-porous material, such as plastic, mylar, films, and others of the like, are widely used for dry erase marker application. These surfaces are commonly referred to as ‘whiteboards’ and are now the most commonplace writing displays used by instructors and students alike.

In use, when the marker is applied to the whiteboard the formulation of the marker ink is such that there is a substantial impairment of permanent adhesion of the ink to the writing surface of the whiteboard. Instead of permanently adhering to the whiteboard, dry marker ink leaves a removable film on top of the whiteboard surface. As is the case with conventional chalkboards, one user's prose is the subsequent user's mess, and the drawings and writings from the earlier use of a white board must be removed by manually erasing them.

A number of materials and apparatus have been tried in the past to provide a means to easily erase the dried ink film left on the whiteboards by dry ink markers. Popular eraser materials include such items as a bristle type eraser (made from many known types of materials), cloth, felt, or simply the user's finger, or more popularly, the side or the back of the user's hand which is holding the dry ink marker.

Unfortunately, such dry ink markers generally are not provided with any erasing component. This of course does not encourage the removal of markings by users and is especially vexing during the use of a marker should the user wish to make a correction. Aftermarket erasers do exist but a chief concern, which is well known about such aftermarket erasers, is that they are configured for use in a manner separated from the marking implement itself. Thus, such conventional dry ink erasers can easily be misplaced and difficult to locate. Further, a user attempting to erase and correct indicia, which they just imparted to the white board, must release their grip on the marker or remove their hand from whiteboard proximity, to employ the eraser. As a consequence, if an eraser component is purchased for the user, it becomes easily lost and unavailable for the user to erase the whiteboard.

As noted, a particularly vexing problem of conventional whiteboard erasers is that of employment during writing. Even if the user has not lost the detached eraser, in order to erase a mistake in writing, or prior writing of themself or another, such a user must let go of the marker held in their hand in an as-used position for writing, and reach for the eraser. Or, they must use their other hand for the eraser, and remove their writing hand from whiteboard proximity.

As is the case, the interruption caused by changing hands to erase and the resulting cessation of writing can cause an interruption of critical thought. This is especially true if the eraser is positioned in a hard to reach location such as the ground or in a drawer. The interruption in such case is even longer and more prone to loss of a thought or the class's attention by the prolonged time needed find the eraser, use it, and then to return to the marker.

U.S. Pat. No. 1,260,881 to Doty provides a chalk holder of longitudinal and radial similarity to a dry erase marker. The device does not include any means of erasing, therefore cannot be adapted to this invention.

U.S. Pat. No. 6,056,468 to Niewiadomski provides a wiper blade adapted to a dry erase marker. The blade is claimed to erase the dried ink but is doing no more then pushing the dried ink aside and does not ‘erase’ its presence. This is insufficient as the amount of dried ink, after excessive use, will accumulate on some section of the writing surface and will eventually need to be ‘erased’ again. This device also requires the user to move the marking device from the as-used position to one more desirable for the wiper blade.

As such, there is a continuing unmet need for an improved device and system of easily engaged marker erasers which will allow for a smoother transition from writing to erasing and back to writing on the whiteboard without having to change the position of the marker in the user's grip. Such a device should be adapted for easy customization by each user and should be lightweight. Further, such a device should allow the user to maintain the marker in their hand, immediately adjacent to the whiteboard in an as-used position ready for writing, and allow for erasing with a simple tip or twist of the hand or arm to erase the marks made by the marker.

### SUMMARY OF INVENTION

The device herein provides a solution to the above noted shortcomings in the prior art. The device provides an easily engaged and employed eraser for the user which is easily engaged to, or formed integral with, the body of the marker being employed. When engaged after manufacture, the device employs means of removable engagement, such as an inwardly biased clip, adhesive, or other means of such engagement, to the base of the device. The base is engaged to an elongated member at a base end (opposite of distal end) of the a curved or malleable member which extends from this engagement to the body of a dry erase style marker. As noted, the member may be engaged to the body of the marker directly in a mode of the device which may be included in an originally manufactured marker from the manufacturer.

The device is configured to allow a highly customized positioning of the eraser tip which is situated at the distal end of the member to thereby adapte the device to the user's individual requirements when holding it in an as-used position. In one mode of the device, a curved member is employed to position the eraser tip forward of the user's palm and over or in front of the distal ends of their fingers gripping the device in an as-used position. In another preferred mode, the positioning of the eraser tip adjacent to the whiteboard for easy erasure by the user is provided by the use of a malleable member. This malleable member, engaged between the base and the eraser tip, allows the user to bend the member and to thereby position the eraser at the distal end in a user-defined position for their individualized ease of use during writing while gripping the marker.

In either mode, because the eraser tip is at the distal end of the member extending from the base in a direction away from their palm, and toward their fingertips, the user may easily position the eraser to erase markings left upon a writing surface while they concurrently hold the marker in the hand in the as-used position. A simple twist of the arm to rotate the eraser tip and member in a direction away from the thumb of the held device, provides an easy contact of the eraser tip with the whiteboard, while the user holds the marker in a writing position next to the whiteboard. As noted, this is a considerable improvement over the prior art requiring separated eraser devices, or those lacking a forward-of-the-palm positioning of the eraser tip while concurrently holding the marker.

Also provided in a preferred mode of the device, is a means for engagement of the device to the whiteboard or a metal surface. In the current mode of the device, a magnet engaged to the base or the elongated member provides that means of engagement through magnetic attraction. Most white boards have a metal surface within and consequently the provision of the magnetic mount provides additional utility in maintaining the device, adjacent to a board on which is to be used when not so engaged.

In use, using the forward curved member, the user positions the eraser tip in a comfortable position substantially overhead of the index finger of their hand which curves around a front surface of the member when holding the device and the marker in an as-used position. Using the malleable member, the user may achieve even greater customization by bending the member to a position wherein the eraser will be generally overhead of one of the fingers of their hand forward of their palm.

Once so positioned over the index finger or in other positions forward of the engagement point of the fingers to the palm of the user, the user may erase errors or prior writings from the whiteboard while holding the marker in the as-used position for writing, adjacent to the whiteboard, by twisting their hand or arm to cause the eraser tip to contact the whiteboard and erase when the user wishes. It is then a quick transition back to writing since their hand never lost its grip on the marker and was never repositioned away from the whiteboard.

When the user is finished, the device, engaged to a marker or not, may be removably engaged with any magnetically attractive mount, using the magnet attached to the base or the member to magnetically engage with that attractive surface.

As noted, the device herein is shown using two modes of engagement to the marker. Removable or semi permanent engagement to the marker is afforded by the base and means for holding a contact to the marker. As shown and described, a clip shaped to form a biased engagement to the exterior of the marker may be used, or adhesive may be employed to hold the engagement, or other means for engagement to the marker as would occur to those skilled in the art.

With respect to the above description, it is to be understood that the invention is not limited in its application to the details of operation of the marker eraser nor the arrangement of the components or steps in the method set forth above or in the following descriptions or in the illustrations in the drawings. The various methods of implementation and operation of the disclosed removably engageable marker eraser herein, are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing similar marker erasers for carrying out the several purposes of the present invention. Therefore, the objects and claims herein should be regarded as including such equivalent construction, steps, and methodology insofar as they do not depart from the spirit and scope of the present invention.

Further objectives of this invention will be brought out in the following part of the specification wherein detailed description is for the purpose of fully disclosing the invention without placing limitations thereon.

It is the object of this invention to provide the user effortless transition from writing on a whiteboard to erasure, by providing a device engageable to the marker and configured for use in such a manner that its comfortable to employ the marker while the eraser is attached, and to erase the whiteboard without moving the user's hand away from proximity to the whiteboard.

It is a further object to provide such a marker eraser which allows the user to predetermine the positioning of the eraser adjacent and overhead of their fingers while in an as-used position holding the marker and an engaged device herein

It is a further object to allow use of the eraser on a dry erase marker without having to disengage the marker from the user's hand in the writing position.

### BRIEF DESCRIPTION OF THE FIGURES

FIG. 1 is a view the device herein positioned for engagement to a dry marker according to the present invention.

FIG. 2 depicts the device of FIG. 1 attached to a dry erase marker using a base having means for attachment to the exterior surface of the marker.

FIG. 3 depicts the device of FIG. 1 showing a malleable member communicating between the base and the eraser tip and which allows the user to customize the position of the eraser tip to individual writing and hand styles.

FIG. 4 shows the device of FIG. 1 from the opposite perspective view and shows the magnet engaged to the base.

FIG. 5 is a bottom perspective view of the device of FIGS. 2-4 showing the base in a biased engagement around the circumference of the marker.

FIG. 6 shows the device as it may be engaged to the marker body during manufacture of the marker wherein the wall forming the marker body engages the base end of the member.

FIG. 7 shows the malleable member of FIGS. 3 and 5, bent to position the eraser tip further forward along the axis of the marker or concurrently a distance away from the axis of the marker.

FIG. 8 depicts the device in an as-used position, in the grip of a user and engaged to a marker showing the member curved forward from the front end of the base and over the distal ends of the user's finger.

### DETAILED DESCRIPTION OF THE PREFERRED EMBODIMENTS OF THE INVENTION

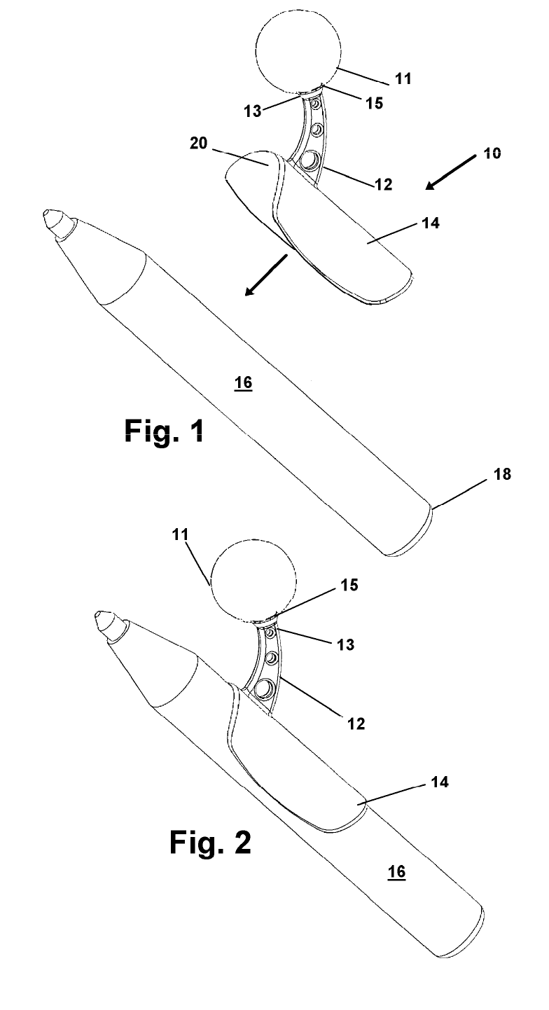

Referring now to the drawings in FIGS. 1-8, wherein similar components are identified by like reference numerals, there is seen in FIGS. 1 and 2, a first mode of the device 10 with eraser material 11 at the distal end of an elongated member 12 which is curved and engaged to a base 14 at the opposite end from the eraser material 11.

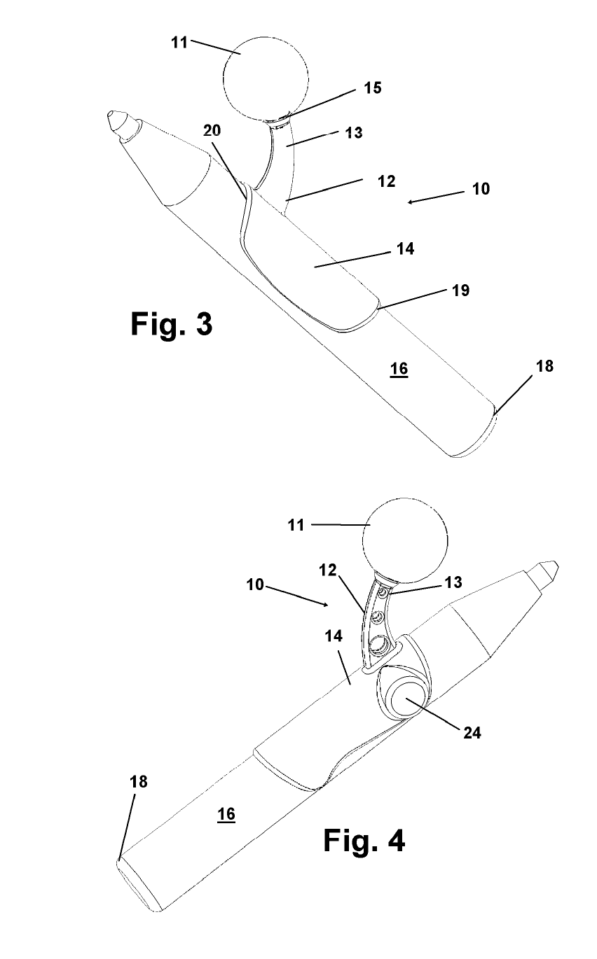

As seen in FIG. 1, the base 14 is configured to engage upon the exterior surface 16 of a whiteboard marker 18 using means of engagement of a first surface 16 to a substantially fixed but removable engagement to the exterior surface 16 of the marker 18. Such a means of engagement in the preferred mode of the device 10 herein employs a base 14 with a curved configuration shown in FIG. 1, adapted to provide a biased engagement to the exterior surface 16 of the marker 18. Alternatively adhesive 19 as in FIG. 3, may be employed to engage the base 14 to the marker 18. Using a biased or adhesive or other engagement to the marker 18, the device is placed in a mounted position as in FIG. 2-5 engaged with the marker 18 in preferably a removable engagement such that the device 10 may be re engaged to multiple markers 18.

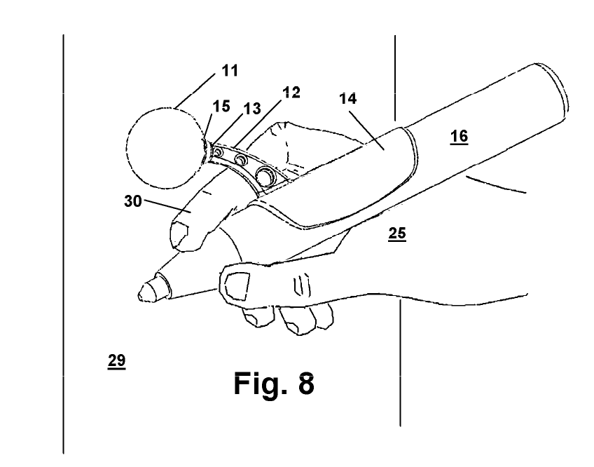

As shown in FIG. 1-2 the member 12 is curved in shape to allow a forward positioning of the eraser material 11 over or adjacent to the distal end of the index or other fingers of the user and hence, close in proximity to the whiteboard when in the as-used position of FIG. 8. The member 12 in FIGS. 3 and 6-7 is shown in curve but malleable form of the member 12 which allows the user to bend it and customize the positioning of the eraser material 11 to their liking. This mode of the device 10 will be especially practical for users with small hands, large hands, or gripping styles. Such users may bend the member 12 to position the eraser material 11 in line with the axis of the marker 18 or off center as desired.

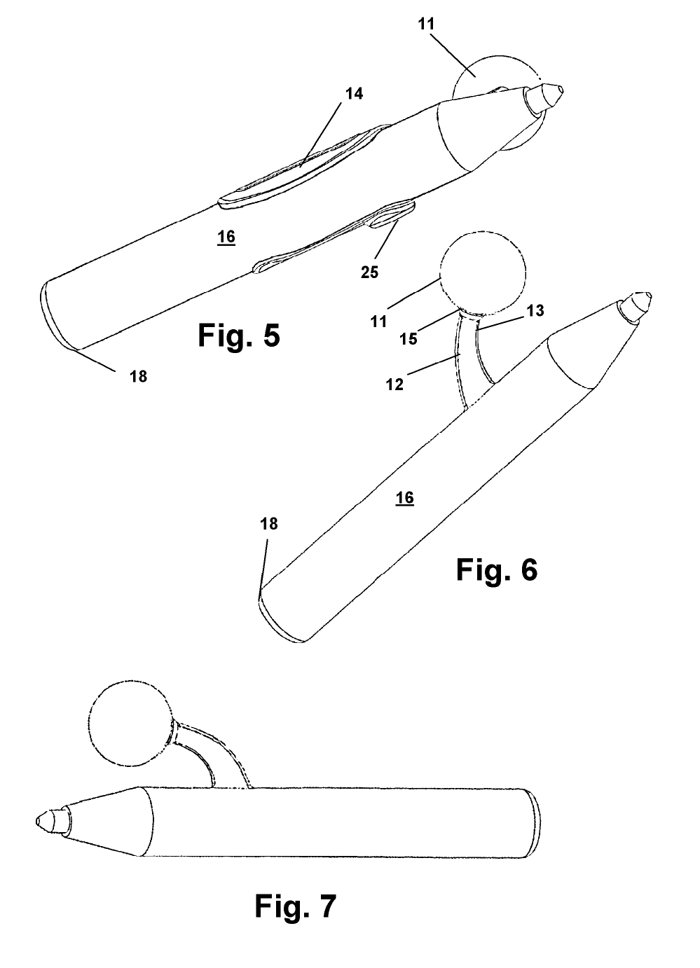

In modes of the device 10 employing a biased frictional engagement of the base 14 to the marker 18, the base is curved in shape and as shown in FIG. 5 from a lower view, wraps around the circumference of the marker 18. The interior cavity of the base 14 in the biased engagement will be smaller than the exterior circumference of the marker 18 occupying the area of contact of the marker 18 with the first surface 16 of the base 14. Thus, when positioned on the marker 18 in an engaged position such as in FIGS. 1-2 and 4, the base 18 being of resilient material such as plastic, will contact the marker 18 in a biased engagement to removably engage it thereto.

Should an adhesive 19 engagement be employed as in FIG. 3, the base 14 need not wrap around the circumference of the marker 18 as far as the biased mode since adhesive 19 will attach the base 14 to the marker 18 rather than an inward bias.

In FIG. 4 there can be seen, the device 10 of FIG. 1 from the opposite perspective view. As shown, a magnet 24 is engaged to the base 14 to provide a means to engage the device to a magnetically attractive surface when not in sue.

FIG. 5 is a bottom perspective view of the device of FIGS. 2-4 showing the base in a biased engagement around the circumference of the marker.

FIGS. 6 and 7 show the device 10 as it may be engaged to the marker 18 during original manufacture of the marker 18. In this mode of the device 10 either the curved and fixed, or the malleable mode of the member 12 may be formed into an engagement extending from the surface 16 of the marker 18. While this mode of the device 10 cannot be removed for reuse on another marker 18, it will provide the optimal positioning of the eraser material 11 such that the user may simply tilt or twist their hand while in the as-used position of FIG. 8, to provide a contact of the eraser material 11 with a whiteboard surface.

In FIG. 8 there is shown the device 10 engaged upon a marker 18 and gripped by the user's hand 25 in an as-used position as it would for writing on a whiteboard 29. As can be seen, while in this position, the device 10 positions the eraser material 11 over or adjacent to the distal end of the index finger 30 or an adjacent figure if the member 12 is malleable, such that rotating the hand 25 will cause the eraser material 11 to contact the whiteboard 29 for erasing. Thus the user need not put down the marker 18, to erase but simply rotates the eraser material 11 against the whiteboard 29 to erase.

The eraser material 11 is currently formed of a material adapted to remove the marker markings from the whiteboard such as sponge material, which may be washed, or cotton, or other material which will erase the marker markings. The eraser material 11 is preferably removably engaged to the distal end 13 of the member 12 such that it may be replaced. The eraser material 11 may be provided in different types of material and more importantly in different sizes to accommodate the user who simply engaged it to the member 12.

As shown in FIG. 8, the eraser material 11 is formed in a globe shape which is especially preferred as it accommodates contacts with the whiteboard 29 from any angle. In FIG. 8, the sponge eraser material 11 formed in a globe is engaged to the distal end 13 of the member 12 by a frictional engagement of an aperture 15 formed axially into the eraser material 11 which forms a biased engagement upon the distal end 13 of the member 12. This is also preferred in that it allows for a quick replacement of the eraser material 11 by pulling the ball or globe shaped eraser material 11 off the member 12, and inserting the distal end 13 of the member 12 into the aperture 15 formed in a replacement piece of eraser material 11 which as noted may be smaller or larger in diameter. The replacement eraser material 11 globes may be provided in a kit of such globe shaped sponge or foam, or fleece or other materials, of varying size and materials, to allow the user to adapted the device 10 to the job and marker 18 to be employed.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. An eraser for a marker held by a user in an as-used position held with the distal ends of the thumb and a finger of said user, comprising:
a member, said member having a first end extending from an engagement to said marker, to a distal end;
erasing material engaged at said distal end of said member; and
said member extending from said engagement to said marker, a distance and in a direction to position said erasing material proximate to a writing end of said marker when held in said as used position.

2. The eraser of claim 1, wherein said engagement to said marker of said first end of said member additionally comprises:
a base; and
means for engagement of said base to an exterior surface of said marker to an engaged position.

3. The eraser of claim 2, wherein said means for engagement of said base to said exterior surface of said marker comprises:
said base dimensioned to engage said exterior surface of said marker in a biased engagement therewith; and
said biased engagement providing means for removable engagement of said base to said marker.

4. The eraser of claim 2, wherein said means for engagement of said base to said exterior surface of said marker comprises:
adhesive engaged in a communication between said base and said exterior surface of said marker.

5. The eraser of claim 1, additionally comprising:
said member having a curved shape between said first end and said distal end; and
said curved shape positioning said distal end and said erasing material thereon, at a position spaced from said writing end of said marker with said thumb or said finger of said user holding said marker in said as-used position within a space formed between said erasing material on a first side and said marker on a second side.

6. The eraser of claim 2, additionally comprising:
said member having a curved shape between said first end and said distal end; and
said curved shape positioning said distal end and said erasing material thereon, at a position spaced from said writing end of said marker with said thumb or said finger of said user holding said marker in said as-used position within a space formed between said erasing material on a first side and said marker on a second side.

7. The eraser of claim 3, additionally comprising:
said member having a curved shape between said first end and said distal end;
said curved shape positioning said distal end and said erasing material thereon, at a position spaced from said writing end of said marker with said thumb or said finger of said user holding said marker in said as-used position within a space formed between said erasing material on a first side and said marker on a second side; and
said biased engagement of said base providing for a sliding of said base and concurrent translation of said erasing material toward or away from said writing end of said marker, whereby said position of said erasing material spaced from said writing end may be adjusted by said translation.

8. The eraser of claim 4, additionally comprising:
said member having a curved shape between said first end and said distal end; and
said curved shape positioning said distal end and said erasing material thereon, at a position spaced from said writing end of said marker with said thumb or said finger of said user holding said marker in said as-used position within a space formed between said erasing material on a first side and said marker on a second side.

9. The eraser of claim 1, additionally comprising:
means for removable engagement of said erasing material to said distal end of said member, whereby said erasing material is replaceable by additional said erasing material adapted to employ said means for removable engagement of said erasing material.

10. The eraser of claim 2, additionally comprising:
means for removable engagement of said erasing material to said distal end of said member, whereby said erasing material is replaceable by additional said erasing material adapted to employ said means for removable engagement of said erasing material.

11. The eraser of claim 3, additionally comprising:
means for removable engagement of said erasing material to said distal end of said member, whereby said erasing material is replaceable by additional said erasing material adapted to employ said means for removable engagement of said erasing material.

12. The eraser of claim 4, additionally comprising:
means for removable engagement of said erasing material to said distal end of said member, whereby said erasing material is replaceable by additional said erasing material adapted to employ said means for removable engagement of said erasing material.

13. The eraser of claim 5, additonally comprising:
means for removable engagement of said erasing material to said distal end of said member, whereby said erasing material is replaceable by additional said erasing material adapted to employ said means for removable engagement of said erasing material.

14. The eraser of claim 6, additonally comprising:
means for removable engagement of said erasing material to said distal end of said member, whereby said erasing material is replaceable by additional said erasing material adapted to employ said means for removable engagement of said erasing material.

15. The eraser of claim 7, additonally comprising:
means for removable engagement of said erasing material to said distal end of said member, whereby said erasing material is replaceable by additional said erasing material adapted to employ said means for removable engagement of said erasing material.

16. The eraser of claim 8, additonally comprising:
means for removable engagement of said erasing material to said distal end of said member, whereby said erasing material is replaceable by additional said erasing material adapted to employ said means for removable engagement of said erasing material.

17. The eraser of claim 2, additonally comprising:
a magnet engaged to said base; and
said magnet providing means of attachment of said eraser for a marker to a magnetically attractive surface.

18. The eraser of claim 6, additionally comprising:
a magnet engaged to said base; and
said magnet providing means of attachment of said eraser for a marker to a magnetically attractive surface.

19. The eraser of claim 10, additionally comprising:
a magnet engaged to said base; and
said magnet providing means of attachment of said eraser for a marker to a magnetically attractive surface.
